(19) United States
(12) Patent Application Publication
(10) Pub. No.: US 2015/0210543 A1
(43) Pub. Date: Jul. 30, 2015

(54) METHOD FOR PREPARATION OF CRYSTALLINE ALANE USING QUARTERNARY AMMONIUM ALUMINUM HYDRIDE

(71) Applicant: INTELLIGENT ENERGY INC., San Jose, CA (US)

(72) Inventor: Allison M. Fisher, Valley City, OH (US)

(73) Assignee: INTELLIGENT ENERGY INC., San Jose, CA (US)

(21) Appl. No.: 14/678,303

(22) Filed: Apr. 3, 2015

Related U.S. Application Data
(63) Continuation of application No. PCT/US2013/054825, filed on Aug. 14, 2013.
(60) Provisional application No. 61/711,238, filed on Oct. 9, 2012.

(51) Int. Cl. C01B 6/06

(52) U.S. Cl. CPC C01B 6/06

(57) ABSTRACT

The invention relates to a method of forming α-alane. The method includes reacting a tetraalkyl ammonium alanate solution in toluene with an alkyl halide or other proton source such as HCl or H₂SO₄.

### CROSS-REFERENCE TO RELATED APPLICATIONS

This patent application is a Continuation of international patent application PCT/US2013/054825 filed Aug. 14, 2013, which claims priority to Provisional patent application 61/711,238 filed Oct. 9, 2012, the disclosures of which are incorporated by reference in their entirety.

### TECHNICAL FIELD

This disclose relates to methods for synthesizing non-solvated alane, which is based on the reaction of quaternary ammonium aluminohydrides and alkyl halides in hydrocarbon solvents, or hydrocarbon solvents containing up to 15% (v/v) of ether. Particle size and crystal structure is determined by reaction time, temperature, stoichiometry and solvent used. With recycling of the quaternary salts and solvents the process is considerably more economical and yields alane with superior properties compared with routes based on the reaction of metal aluminum hydride with aluminum chloride.

### BACKGROUND

A limiting factor in the widespread adoption of proton exchange membrane fuel cell (PEMFC) based power systems is hydrogen fuel storage. The development of a viable hydrogen storage solution will have a profound impact on how consumer's will power portable devices, since batteries simply cannot match demands for runtime, energy density and reliability.

Because hydrogen has poor energy content per volume (0.01 kJ/L at STP and 8.4 MJ/L for liquid hydrogen vs. 32 MJ/L for petroleum), physical transport and storage as a gas or liquid is impractical. Additionally, the compression process to achieve the pressures necessary to reach a high density is energy-intensive and doesn't solve the hazard issue. Also, the densities of compressed H2 or liquefied H2 are still below those required to reach practical fuel storage goals.

Physical means to store hydrogen include sorbents such as carbon nanotubes and foams, zeolites, metal-organic frameworks; and intermetallics such as titanium-manganese alloy 5800, complex hydrides such as metal alanates, amides, and borohydrides, and chemical hydrides such as sodium borohydride/water and ammonia borane (AB). Despite intensive and elegant work on sorbents and complex hydrides, practical systems that can store and release ≧6 wt % hydrogen at moderate temperatures are still far from realization.

Alane is an attractive candidate for solid hydrogen storage and release because it has a density of 1.48 g/c^{m3} and releases up to 10 wt % hydrogen and aluminum in a single step upon heating to ≦200° C. Alane's formula is sometimes represented with the formula (Al_{H3})ₙ because it is a polymeric network solid. Alane is formed as numerous polymorphs: the alpha (α), alpha prime (α′), beta (β), delta (δ), epsilon (δ), zeta (ζ), or gamma (γ) polymorphs. Each of the polymorphs has different physical properties and varying stability. The most thermally stable polymorph is α-alane, featuring aluminum atoms surrounded by six hydrogen atoms that bridge to six other aluminum atoms. The Al—H distances are all equivalent and the Al—H—Al angle is approximately 141°. While α-alane's crystals have a cubic or hexagonal morphology, α′-alane forms needlelike crystals and γ-alane forms a bundle of fused needles. Typically, the lightweight, unstable γ-alane is produced first, converting under certain conditions to the more stable rhombohedral β-alane polymorph first, then to α-alane. When trace amounts of water are present during crystallization the δ-alane and ε-alane can be fanned. The ζ-alane polymorph is prepared by crystallization from di-n-propyl ether. The α′, δ, ε, and ζ polymorphs do not convert to α-alane upon heating and are less thermally stable than α-alane.

Crystalline alane has many uses including: hydrogen storage, inorganic and organic synthesis, as an ingredient in propellants and pyrotechnics, as a polymerization catalyst, and as a precursor to aluminum films and coatings. Consequently there has been considerable research carried out on the preparation of alane, since the first report of its preparation in 1942 (Stecher and Wiberg, Ber. 1942, 75, 2003). Finholt, Bond, and Schlesinger reported an improved method of synthesis of alane-diethyl etherate in 1947 which has formed the foundation for most of the reported methods for the synthesis of non-solvated crystalline alane (J. Am. Chern. Soc., 1947, 69, 1199). The reaction is shown below, and the amount of ether complexed to the alane product depended on the length and temperature of the drying step of the reaction.

3LiAlH₄+AlCl₃→4AlH₃+3LiCl

Reports describing the preparation and stabilization of non-solvated crystalline alane began to appear in the patent literature in 1974 (Scruggs, U.S. Pat. No. 3,801,657, Roberts et al. U.S. Pat. No. 3,803,082, King, U.S. Pat. No. 3,810,974, Matzek et al. U.S. Pat. No. 3,819,819, Daniels et al. U.S. Pat. No. 3,819,335, Roberts, U.S. Pat. No. 3,821,044, Brower et al. U.S. Pat. No. 3,823,226, Schmidt et al. U.S. Pat. No. 3,840,654, and Self et al. U.S. Pat. No. 3,844,854). Removal of the residual diethyl ether (“desolvation”) was effected by using higher than stoichiometric ratios of complex aluminum hydride to aluminum chloride, as well as inclusion lithium borohydride as a “seeding” or “crystallization” agent. Several patents describe the use of sodium aluminum hydride instead of lithium aluminum hydride (Ashby et al. U.S. Pat. No. 3,829,390, and Kraus et al. U.S. Pat. No. 3,857,930). As disclosed in these patents and Brower et al. (“Brower”), “Preparation and Properties of Aluminum Hydride,” J. Am. Chern. Soc., 1976, 98, 2450, alane is usually synthesized by reacting aluminum trichloride (AlCl₃) and metal aluminum hydride (MAlH₄) in diethyl ether or diethyl ether-hydrocarbon solvent mixtures. The aluminum trichloride was dissolved in diethyl ether at −10° C. A minimum of three mole equivalents of MAlH₄ was added to the aluminum trichloride solution to produce a solvated alane-ether complex and a precipitate of metal chloride (MCl, e.g. LiCl or NaCl). In order to desolvate the alane-ether complex, 0.5 to 4.0 mole equivalents of a borohydride salt, such as lithium borohydride or sodium borohydride, was mixed with the solution including the alane-ether complex. The mixture was filtered and the filtrate was diluted with toluene or benzene to provide an ether to toluene or benzene ratio of 15:85. The mixture was heated to 85° C. to 95° C. to desolvate the alane-ether complex and the diethyl ether was subsequently removed by distillation. The precipitated alane was recovered by aqueous acid quenching, filtration, and washing. Brower also discloses that the reaction is conducted in the absence of water, oxygen, and other reactive species because if water is present, the 8 and s polymorphs are undesirably formed.

The methods reported for stabilization of the reactive alane product during this time included in situ or subsequent treatment of alane with an alkyl or aryl silicol, coating the alane surface with an organic compound containing at least one phenyl group or a condensed ring structure, and washing the alane product (often with some amount of magnesium included in the preparation step) with an aqueous solution buffered at from about pH 6 to 8.

However, the large volumes of solvent required as well as the excess aluminohydride and borohydride salts used to desolvate the alane-ether complex make these syntheses of α-alane expensive. The borohydride salts also generate byproducts that require disposal. Furthermore, the alane produced by the method of Brower is typically contaminated with undesirable polymorphs and is prone to decomposition during desolvation.

Current methods for the preparation of alane are expensive because of, among other things, the high cost of the large amounts of solvent needed to prepare the stable α-alane crystalline phase. It would be desirable to reproducibly produce a high yield of α-alane using a low-cost method.

An object of the present invention is to provide an improved low-cost method for the preparation of α-alane suitable for use as a solid hydrogen storage and release material.

These and other advantages of the invention will be further understood and appreciated by those skilled in the art by reference to the following written specification, claims, and appended drawings.

### SUMMARY

Solid hydrogen storage is done through the preparation of alane. The alane is preferably in the α-alane crystalline form. The α-alane is manufactured by reacting an alkyl halide such as benzyl chloride with a tetraalkyl ammonium alanate solution in toluene. Alternatively, the quaternary ammonium aluminohydride could be reacted with one molar equivalent of a proton source such as HCl or H₂SO₄ instead of an alkyl halide.

According to one aspect of the invention, α-alane is produced by a method including the steps: preparing a tetraalkyl ammonium alanate solution in toluene; heating the solution while adding an alkyl halide to produce crystals for nucleation; after producing the crystals for nucleation, slowly adding alkyl halide to produce alane, toluene, and tetraalkyl ammonium chloride; continuing to heat the solution so that the alane that is formed is in the a-crystalline phase; and removing the α-alane crystals by filtration, leaving tetraalkyl ammonium halide in toluene solution as the filtrate. Embodiments can include one or a combination of the following:
sufficient alkyl halide is added to make the solution 0.005 M;
the tetraalkyl ammonium alanate solution in toluene is prepared by the metathesis of a tetraalkyl ammonium halide and an alkali metal alanate in a toluene solution;
the alkali metal halide is filtered from the solution;
the alkali metal halide is sodium halide;
the alkali metal halide is lithium halide;
the method is continuous and the filtrate is used to create the tetraalkyl ammonium alanate solution in toluene by the addition of a alkali metal alanate;
the crystallizing the α-alane comprises heating the solution to a temperature range from approximately 50° C. to approximately 95° C.; the temperature range can be from approximately 60° C. to approximately 65° C.; the temperature range can be from approximately 65° C. to approximately 87° C.; the temperature range can be from approximately 88° C. to approximately 95° C.; the temperature range can be from approximately 50° C. to approximately 60° C.
the crystallizing the α-alane comprises heating the solution to a temperature range from approximately 50° C. to approximately 95° C.; the temperature range can be from approximately 60° C. to approximately 65° C.; the temperature range can be from approximately 65° C. to approximately 87° C.; the temperature range can be from approximately 88° C. to approximately 95° C.; the temperature range can be from approximately 50° C. to approximately 60° C.

According to another aspect of the invention, α-alane is produced by a method including the steps: preparing a tetraalkyl ammonium alanate solution in toluene; adding sufficient tetrahydrofuran to produce alane, toluene, and a tetraalkyl ammonium compound; and removing the α-alane crystals by filtration, leaving tetraalkyl ammonium halide in toluene solution as the filtrate. Embodiments can include one or a combination of the following:
the tetraalkyl ammonium alanate solution in toluene is prepared by the metathesis of a tetraalkyl ammonium halide and an alkali metal alanate in a toluene solution;
the alkali metal halide is filtered from the solution;
the alkali metal halide is sodium halide;
the alkali metal halide is lithium halide;
the method is continuous and the filtrate is used to create the tetraalkyl ammonium alanate solution in toluene by the addition of a alkali metal alanate; and
the crystallizing the α-alane comprises heating the solution to a temperature range from approximately 50° C. to approximately 95° C.; the temperature range can be from approximately 60° C. to approximately 65° C.; the temperature range can be from approximately 65° C. to approximately 87° C.; the temperature range can be from approximately 88° C. to approximately 95° C.; the temperature range can be from approximately 50° C. to approximately 60° C.

### BRIEF DESCRIPTION OF THE DRAWING

FIG. is a schematic diagram showing a reaction process according to the invention.

### DETAILED DESCRIPTION OF THE PREFERRED EMBODIMENTS

The embodiments of the present inventions described below are not intended to be exhaustive or to limit the invention to the precise forms disclosed in the following detailed description. Rather the embodiments are chosen and described so that others skilled in the art may appreciate and understand the principles and practices of the present inventions.

All publications and patents mentioned herein are incorporated herein by reference in their respective entireties for the purpose of describing and disclosing, for example, the constructs and methodologies that are described in the publications which might be used in connection with the presently described invention. The publications discussed above and throughout the text are provided solely for their disclosure prior to the filing date of the present application. Nothing herein is to be construed as an admission that the inventor is not entitled to antedate such disclosure by virtue of prior invention.

For purposes of description herein, the terms “upper,” “lower,” “right,” “left,” “rear,” “front,” “vertical,” “horizontal,” and derivatives thereof shall relate to the invention as oriented in the figures. However, it is to be understood that the invention may assume various alternative orientations and step sequences, except where expressly specified to the contrary. It is also to be understood that the specific parts, devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

### α-Alane

In one aspect, the invention relates to hydrogen storage compositions containing alane. As used herein, “alane” refers to AlH₃, and includes combinations of the different alane polymorphs. In contrast, when referring to a specific polymorph of alane, the designation of the specific polymorph is used, such as “α-alane.”

The alane can have any acceptable purity level. Preferably for fuel cell applications, the alane is free of organic contaminants. For example, the alane is preferably non-adducted and non-solvated by organic species. The hydrogen storage compositions of the present invention can also have a number of applications other than fuel cells. For some of these other applications, e.g., as catalysts, chemical reactants, propellant, and so on, the alane may contain organic species.

The alane can be completely composed (i.e., 100% by weight) of any of the alane compositions described above. Alternatively, the alane can include another compound or material which is not an alane polymorph.

The alane can also be in any suitable physical form. For example, the alane can be in particulate form, e.g., powder, crystalline, polycrystalline, microcrystalline, pelletized, granular, and so on. The size of the alane particles is not particularly critical to the operability of the present invention. For example, any one or more dimensions of the particles can be one centimeter or less, 50 millimeters or less, 40 millimeters or less, 30 millimeters or less, 20 millimeters or less, 10 millimeters or less, 1 millimeter or less, 500 microns or less, 250 microns or less, 100 microns or less, 50 microns or less, 20 microns or less, 10 microns or less, 1 micron or less, 500 nanometers or less, 250 nanometers or less, 100 nanometers or less, 50 nanometers or less, and so on. In preferred embodiments, the alane is composed of particles of 1 to 250 microns or 50 to 100 microns. The particles of alane can also have any of several morphologies. For example, the particles can be approximately spherical, oblong, rectangular, square planar, trigonal bipyramidal, cylindrical, octahedral, cubooctahedral, icosahedral, rhombohedral, rod-shaped, cuboidal, pyramidal, amorphous, and so on. Alternatively, the alane can be in non-particulate form, e.g., in block form, in sheet form, as a coating, a film, an interconnected or interwoven network, or a combination thereof

The alane composition is capable of efficiently and controllably producing hydrogen for a sustained period of time. For example, for fuel cell applications, it would be particularly preferred for the alane composition to be capable of releasing adequate levels of hydrogen at a steady rate for a period of several hours or days. For applications where hydrogen demand varies with time, it is possible and preferable to vary the hydrogen desorption rate by varying the temperature.

In some instances, the alane is in a modified form. The modified form can be, for example, a purified form in which the alane was prepared and maintained (stored) in a reduced oxygen, oxygen-free, low humidity, and/or zero humidity environment. Such purified forms of alane also contain low levels of impurities. The modified form can also be, for example, a specific crystalline phase or mixture of specific phases of alane. For example, the alane can be partially, or wholly, enriched in one or more of the crystalline phases. The crystalline phases can be present in amounts of, for example, one, five, ten, twenty, fifty, sixty, seventy, eighty, ninety, ninety-five, and higher weight percents, of the total amount of alane.

In some instances, the modified alane is a purified alane composed completely of one or more crystalline phases. In a preferred embodiment, the purified crystalline alane is composed completely of the a phase or a combination that includes α-alane.

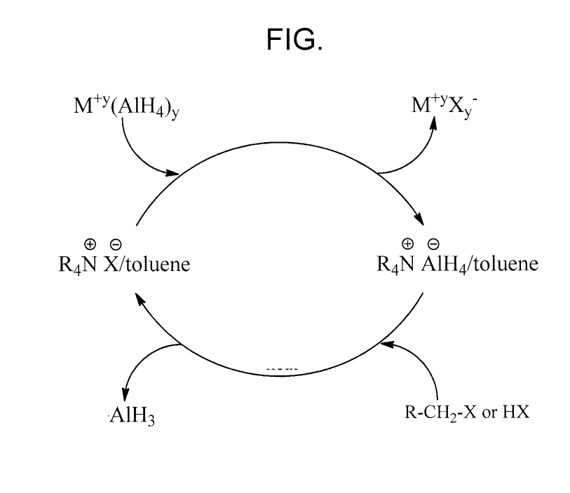

The scheme in FIG. 1 illustrates the reaction process for making alane, which may be done either by batch or continuous mode. In FIG. 1, R is an alkyl or aryl group; X is Br⁻¹, or Cl⁻¹; I⁻¹, and M is Li⁺¹, Na⁺¹; Mg⁺² or Ca⁺².

One example of the above process is where tetraalkyl ammonium alanate solution in hydrocarbon solvent is prepared by the metathesis of tetraalkyl ammonium halide and sodium or lithium alanate in tetrahydrofuran or toluene solution. The sodium or lithium halide is removed from solution by filtration. The filtrate is cooled in an ice-water bath and benzyl chloride is added. Benzyl chloride is reduced by tetraalkyl ammonium alanate to produce AlH₃, toluene, and tetraalkyl ammonium chloride. Since AlH₃ is not generally soluble in hydrocarbon it should precipitate, while the tetraalkyl ammonium chloride remains in solution. The alane can be removed by filtration, rinsed with hydrocarbon and the filtrate recovered for recycle. The isolated alane can be converted to the pure alpha morphology by heat treatment and stabilized as described in the literature. The recovered filtrate is identical to the starting solution used to make the tetraalkyl ammonium alanate solution, and with no other impurities it should be possible to re-use it directly.

While the above scheme and examples describe preferred reaction processes, those skilled in the art will realize that other and further embodiments can be made without departing from the spirit of the inventive method of making α-alane. It should be noted that the operating temperatures and solvent may be altered and still result in the production of a-alane. In addition, the quaternary ammonium halide salt could be altered or a different salt used to form α-alane. In addition, the alkyl halide that is reduced by [AlH₄ to form AlH₃ can also be altered, or replace by a suitable proton source, such as H₂SO₄, CH₃SO₃H, or HCl.

A crystallization additive may be added to help form the α-alane crystals. The crystallization additive may promote growth of the a polymorph by providing a nucleation site for the a polymorph. The crystallization additive may also suppress formation of the undesirable polymorphs. It is also believed that early precipitation of the crystals may promote the growth of the a polymorph. Seed crystals of α-alane may be added during the crystallization to promote the growth of the α-alane. The seed crystals may subsequently be incorporated into the α-alane.

The crystallization additive may also be an aprotic, electron-rich material. For instance, the crystallization additive may be an olefin, a polyolefin, an anisole, a polydimethyl siloxane, a tertiary amine, an aliphatic or aromatic ether, or mixtures thereof. The olefin may include, but is not limited to, squalene, cyclododecatriene, norbornylene, norbornadiene, a phenyl terminated polybutadiene, and mixtures thereof. The anisole may include, but is not limited to, 2,4-dimethyl anisole, 3,5-dimethyl anisole, 2,6-dimethyl anisole, and mixtures thereof. These compounds are commercially available from various manufacturers, such as from Sigma-Aldrich Co. (St. Louis, Mo.). The crystallization additive may also be polydimethyl siloxane, diethyl ether, dipropyl ether, methyl tert-butyl ether.

Multiple crystallization additives may also be used, including a combination of seed crystals and one of the other crystallization additives such as LiBH₄.

When an ether is added, the ether may be removed by distillation as described in French Patent No. FR2245569 (1975). Distillation can be carried out between 50° and 85° C. At the bottom of this range, between 50° and 65° C., etherate intermediate is formed and is converted into aluminum hydride stable. However, at the top of this range, between 65° and 85° C., etherate aluminum hydride does not appear and stable α-alane precipitates are formed almost immediately. By keeping the mixture in 8% to 10% of ether after the initial distillation, a final α-alane product may be obtained with superior features. Retention of the ether allows the rearrangement of alane during the conversion to the a form of alane as thermal decomposition of the crystal is reduced and the final product is crystalline. Other methods of desolvation include, but are not limited to, those described in Brower et al. (1975), U.S. Pat. No. 7,238,336; U.S. Pat. No. 3,801,657; U.S. Pat. No. 3,453,089; and in A. N. Tskhai et al. Rus. J. Inorg. Chem. 37:877 (1992).

The α-alane crystals may be stabilized using methods described in the literature, such as washing with an aqueous acidic solution to remove any impurities, such undesirable polymorphs or other impurities that exist as a result of the starting materials or the reaction process. The acidic solution may include from approximately 1% by volume to approximately 25% by volume of an acid, such as HCl, hydrofluoric acid, hydrobromic acid, phosphoric acid, perchloric acid, sulfuric acid, boric acid, or mixtures thereof. The acidic solution may include approximately 0.1% by volume to approximately 12% by volume of HCl. The crystals of the α-alane may then be filtered to remove the acidic solution. The α-alane crystals may be rinsed with water to remove remaining trace amounts of the acidic solution, followed by rinses with acetone or isopropanol to remove the water. The α-alane crystals may then be dried.

Examples have been set forth below for the purpose of illustration and to describe the best mode of the invention at the present time. However, the scope of this invention is not to be in any way limited by the examples set forth herein.

### Example 1

### Preparation of Tetrahexylammonium Aluminohydride

A dry 250 mL flask equipped with a magnetic stir bar was charged with tetrahexylammonium bromide (10.7 g, 0.0246 mol) then sealed with a rubber septum and purged with Ar. To this flask was added 30 mLs of dry tetrahydrofuran. A second dry 250 mL round bottom flask equipped with a magnetic stir bar was charged with sodium aluminum hydride (NaAlH₄, 1.33 g, 0.0246 mol), sealed with a rubber septum, and flushed with argon. To this flask was added 75 mLs of dry tetrahydrofuran. The tetrahexylammonium bromide solution was then transferred using a cannula to the stirring mixture of NaAlH₄ in tetrahydrofuran. A white precipitate began to form immediately. The reaction mixture was allowed to stir under Ar overnight at room temperature. At the end of the reaction period, the suspension was filtered. Tetrahydrofuran was removed from the filtrate at 30° C. using a rotary evaporator and purged with Ar. The resulting product was dried overnight at room temperature under vacuum. Isolated: 9.14 g (96% of theoretical).

### Example 2

### Preparation of Tetraoctylammonium Aluminohydride

A dry 250 mL flask equipped with a magnetic stir bar was charged with tetraoctylammonium bromide (15 g, 0.0274 mol) then sealed with a rubber septum and purged with Ar. To this flask was added 60 mLs of dry tetrahydrofuran, followed by warming to 50° C. in order to dissolve the tetraoctylammonium bromide. A second dry 250 mL round bottom flask equipped with a magnetic stir bar was charged with sodium aluminum hydride (NaAlH₄, 1.48 g, 0.0274 mol), sealed with a rubber septum, and flushed with argon. To this flask was added 60 mLs of dry tetrahydrofuran. The warm tetraoctylammonium bromide solution was then transferred using a cannula to the stirring mixture of NaAlH₄ in tetrahydrofuran. A white precipitate began to form immediately. The reaction mixture was allowed to stir under Ar overnight at room temperature. At the end of the reaction period, the suspension was filtered. Tetrahydrofuran was removed from the filtrate at 30° C. using a rotary evaporator and purged with Ar. The resulting product was dried overnight at room temperature under vacuum. Isolated: 11.63 g (85% of theoretical).

### Example 3

### Preparation of Alane by Reduction of Alkyl Halides with Quaternary Ammonium Aluminohydride

A 0.22M toluene solution of the quaternary ammonium aluminohydride is prepared with stirring under inert atmosphere at ambient temperature. An alkyl halide such as benzyl chloride is made 0.5M in toluene- and added to the quaternary ammonium alanate solution slowly while cooling the solution in an ice-water bath. A slight molar excess of the alkyl halide is preferred. The course of the reaction can be monitored by GC. When the reaction is complete, as indicated by the absence of starting material in the GC trace, the suspension is diluted with toluene and filtered under inert atmosphere. The product is washed three times with toluene. The product is then dried overnight in vacuo at ambient temperature, followed by heating at 75° C. to furnish pure α-alane.

### Example 4

### Preparation of Alane by Reduction of Alkyl Halides with Quaternary Ammonium Aluminohydride

Tetra-n-pentadecylammonium aluminohydride is prepared as described by Ehrlich in U.S. Pat. No. 3,417,119. After dissolving this salt in toluene or heptane, an alkyl halide such as 1-iodohexane-made 0.5M in toluene- is added to the quaternary ammonium alanate solution slowly while cooling the solution in an ice-water bath. A slight molar excess of the alkyl halide is preferred. The course of the reaction can be monitored by GC. When the reaction is complete, as indicated by the absence of starting material in the GC trace, the suspension is diluted and filtered under inert atmosphere. The product is washed three times with toluene. The product is then dried overnight in vacuo at ambient temperature, followed by heating at 75° C. to furnish pure α-alane.

The above descriptions are exemplars only. They are non-limiting, provided as illustrative and not intended to be an exhaustive list of all the aspects of the disclosure. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

1. A method of producing α-alane comprising:
preparing a tetraalkyl ammonium alanate solution in toluene;
heating the solution while adding an alkyl halide to produce crystals for nucleation; after producing the crystals for nucleation, slowly adding alkyl halide to produce alane, toluene, and tetraalkyl ammonium chloride;
continuing to heat the solution so that the alane that is formed is in the α-crystalline phase; and,
removing the α-alane crystals by filtration, leaving tetraalkyl ammonium halide in toluene solution as the filtrate.

2. The method of claim 1, wherein sufficient alkyl halide is added to make the solution 0.005 M.

3. The method of claim 1, wherein the tetraalkyl ammonium alanate solution in toluene is prepared by the metathesis of a tetraalkyl ammonium halide and an alkali metal alanate in a toluene solution.

4. The method of claim 1, wherein the alkali metal halide is filtered from the solution.

5. The method of claim 1, wherein the alkali metal halide is sodium halide.

6. The method of claim 1, wherein the alkali metal halide is lithium halide.

7. The method of claim 1, wherein the method is continuous and the filtrate is used to create the tetraalkyl ammonium alanate solution in toluene by the addition of a alkali metal alanate.

8. The method of claim 1, wherein the crystallizing the α-alane comprises heating the solution to a temperature range from 50° to 95° C.

9. The method of claim 8, wherein the temperature range is from 60° to 65° C.

10. The method of claim 8, wherein the temperature range is from 65° to 87° C.

11. The method of claim 8, wherein the temperature range is from 88° to 95° C.

12. The method of claim 8, wherein the temperature range is from 50° to 60° C.

13. A method of producing α-alane comprising:
preparing a tetraalkyl ammonium alanate solution in toluene;
adding sufficient tetrahydrofuran to produce alane, toluene, and a tetraalkyl ammonium compound; and,
removing the α-alane crystals by filtration, leaving tetraalkyl ammonium halide in toluene solution as the filtrate.

14. The method of claim 13, wherein the tetraalkyl ammonium alanate solution in toluene is prepared by the metathesis of a tetraalkyl ammonium halide and an alkali metal alanate in a toluene solution.

15. The method of claim 13, wherein the alkali metal halide is filtered from the solution.

16. The method of claim 13, wherein the alkali metal halide is sodium halide.

17. The method of claim 13, wherein the alkali metal halide is lithium halide.

18. The method of claim 13, wherein the method is continuous and the filtrate is used to create the tetraalkyl ammonium alanate solution in toluene by the addition of a alkali metal alanate.

19. The method of claim 13, wherein the crystallizing the α-alane comprises heating the solution to a temperature range from 50° to 95° C.

20. The method of claim 19 wherein the temperature range is from 60° to 65° C.

21. The method of claim 19 wherein the temperature range is from 65° to 87° C.

22. The method of claim 19 wherein the temperature range is from 88° to 95° C.

23. The method of claim 19 wherein the temperature range is from 50° to 60° C.
